(19) United States
(12) Patent Application Publication
(10) Pub. No.: US 2015/0253594 A1
(43) Pub. Date: Sep. 10, 2015

(54) Adjustable Tint

(71) Applicants: Albert Roberts, Richmond, VA (US); Kimberly Haskins, Richmond, VA (US)

(72) Inventors: Albert Roberts, Richmond, VA (US); Kimberly Haskins, Richmond, VA (US)

(21) Appl. No.: 14/643,645

(22) Filed: Mar. 10, 2015

Related U.S. Application Data
(60) Provisional application No. 61/950,313, filed on Mar. 10, 2014.

(51) Int. Cl. G02F 1/01; G02B 5/23

(52) U.S. Cl. CPC G02F 1/0126; G02B 5/23

(57) ABSTRACT

An apparatus for adjusting tint level by producing varying degrees of ultraviolet light is provided. The apparatus includes a window, a plurality of ultraviolet lights, a sensor, and an integrated control key. The window includes at least a transparent interior pane and a transparent exterior pane. A plurality of ultraviolet lights are disposed on the exterior pane of the window. The ultraviolet lights are molded onto an outer perimeter of the exterior pane. A sensor may be coupled to the ultraviolet lights. The sensor is configured to detect an output of the ultraviolet lights. An integrated control key is coupled to the sensor and is configured to be user controlled to adjust the tint percentage produced by the ultraviolet lights on the windshield.

### CROSS REFERENCE TO RELATED APPLICATION

This application claims the benefit of U.S. Provisional Application No. 61/950,313 filed on Mar. 10, 2014. The above identified patent application is herein incorporated by reference in its entirety to provide continuity of disclosure.

### FIELD OF THE INVENTION

The present invention generally relates to adjustable tints. More particularly, the present invention relates to adjustable tints using ultraviolet lights to adjust the level of the tint on a windshield.

### BACKGROUND OF THE INVENTION

Many individuals in modern society use automobiles for work, school, or recreation. Automobiles offer consumers a simple and efficient means of traveling from one destination to the next. Most considerate drivers realize the importance of staying alert behind the wheel and because of this pay close attention to the comings and goings of traffic, their speed, road signs, stop lights, and other known hazards of the road.

Unfortunately, as many drivers would attest, there are those obstacles that even the most conscientious of drivers cannot avoid. In particular, driving in the direction of sunlight can be both difficult and dangerous. Incoming sunlight often results in unavoidable “blind spots,” the glare of intense sunlight can make it almost impossible to see the road ahead. The low-contrast vision caused by glare from the sun may be distracting and may directly affect driving comfort and safety. Burning of the eyes, fatigue, and eye strain are often symptoms of blinding glare caused by ultraviolet rays which may make even the shortest of journeys unsafe, exhausting, and stressful.

Traditional tinted windows offer the advantage of reducing the amount of glare, providing privacy, and making the contents of the interior of a vehicle more difficult to discern, but there are many occasions when it is desirable to have unobstructed vision which may be best realized with non-tinted windows. Further, many local and state governments have specific guidelines for the degree to which a window may be tinted. Consequently, if a vehicle's windows are tinted a shade too dark for these guidelines, the vehicle's operator may be subject to serious fines and penalties. It is desirable that driving be made safe and comfortable for drivers and passengers, as well as the vehicle be protected from the damaging effects of the sun.

For example, an adjustable tint window with an electrochromatic conductive polymer is illustrated in U.S. Pat. No. 5,042,923, which includes first and second window panes delimiting a cavity containing an ion-conducting electrolyte that contacts opposing surfaces of the first and second window panes. Applying a potential between the first and second window panes provides a selected amount of light transmittance upon a passage of current therebetween.

U.S. Pat. No. 4,948,705, discloses a photochromatic glass highlight mask. The highlight mask is especially suited for printing from positive color transparencies and is made of a photochromatic glass such as Corning “PHOTOGRAY EXTRA” sunglass lens material.

While these devices fulfill their respective, particular objectives and requirements, the aforementioned patents do not describe a selectively variable window tinting system for limiting the passage of visible light and radiative heat through an automobile window. Therefore, the present invention attempts to overcome deficiencies present in conventional automobile glass by providing window glass which is adapted to be selectively tinted during the day time and can remain clear for nighttime driving.

Ideally, a user-preferred vehicle window tinting system should be safe in operation, operate reliably, and be manufactured at a modest expense. Thus, a need exists for a tinting system for vehicle windows allowing the vehicle driver to adjust the level of the window's tint in a convenient and efficient manner.

### SUMMARY OF THE INVENTION

In view of the foregoing disadvantages inherent in the known types of tinted window systems now present in the prior art, the present invention provides an adjustable window tinting system utilizing ultraviolet light for providing convenience for the user when adjusting window tint in different weather conditions or times of the day when more light is present. As such, the general purpose of the present invention, which will be described subsequently in greater detail, to provide a new adjustable window tinting system apparatus which has many of the advantages of the tinted windows mentioned heretofore and many novel features that result in an adjustable window tinting system which is not anticipated, rendered obvious, suggested, or even implied by any of the prior art tinted windows, either alone or in any combination thereof.

According to one embodiment of the present invention, an apparatus for adjusting tint level by producing varying degrees of ultraviolet light is provided. The apparatus includes a windshield. The windshield includes at least a transparent interior pane and a transparent exterior pane. The interior pane and exterior pane are substantially parallel. A plurality of ultraviolet lights may be disposed on the exterior pane of the windshield. The ultraviolet lights are molded onto an outer perimeter of the exterior pane of the windshield. A sensor may be coupled to the ultraviolet lights. The sensor is configured to detect an output of the ultraviolet lights. The apparatus may further include an integrated control key. The integrated control key is configured to control a percentage of tint produced by the ultraviolet lights on the windshield.

According to another embodiment of the present invention, the ultraviolet lights may be configured to change a light transmissivity of the windshield responsive to an electric signal provided to the ultraviolet light. The sensor detects the output of light from the ultraviolet lights with a photo sensor. The photo sensor converts light energy to an electrical signal output.

According to yet another embodiment of the present invention, the ultraviolet lights may be disposed between interior pane and exterior pane. The light emitted from the ultraviolet lights may adjust the tint between 5% and 50% visibility.

In still yet another example embodiment of the present invention, the integrated control key may be located on a vehicle dashboard. The integrated control key may be coupled to a digital display that indicates a tint percentage. The integrated control key is configured to receive a user input signal and adjust the electric signal responsive to the received input.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a windshield with an adjustable tint according to one embodiment of the present invention.

FIG. 2 shows a perspective view of a car windshield with an adjustable tint according to one embodiment of the present invention.

FIG. 3 shows an integrated control key for adjusting the window tint according to one embodiment of the present invention.

FIG. 4 shows a schematic view of the control system for the adjustable tint system according to one embodiment of the present invention.

### DETAILED DESCRIPTION OF THE INVENTION

Reference is made herein to the attached drawings. Like reference numerals are used throughout the drawings to depict like or similar elements of the adjustable window tinting system. For the purposes of presenting a brief and clear description of the present invention, the preferred embodiment will be discussed as used for car windshields. The figures are intended for representative purposes only and should not be considered to be limiting in any respect.

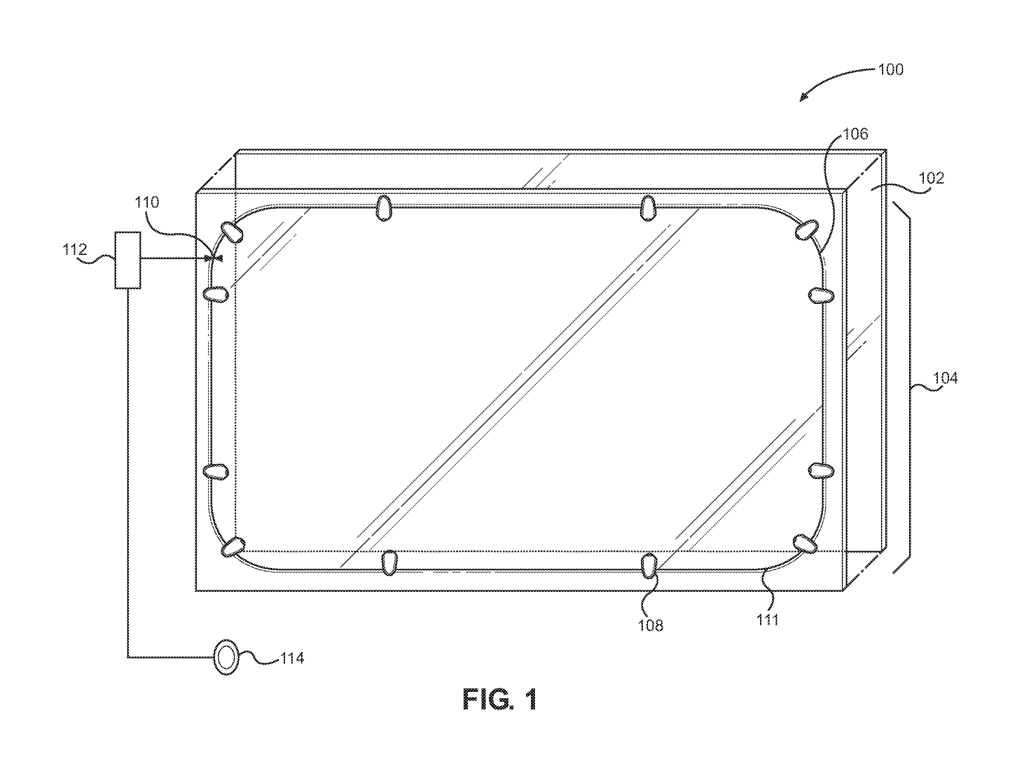

Referring now to FIG. 1, there is shown an apparatus 100 for adjusting tint level by producing varying degrees of ultraviolet light. The apparatus 100 includes a window or windshield 102 comprising at least a transparent interior pane 104 and a transparent exterior pane 106. The interior pane 104 and exterior pane 106 are in a substantially parallel configuration. In a preferred embodiment, there is a space provided between the exterior pane and the interior pane. A fluid, such as a gas, can be provided in the space between the interior pane 104 and the exterior pane 106, providing thermal insulation properties. In one embodiment, the window comprises a photochromic film layer.

A plurality of ultraviolet lights 108 may be disposed on the exterior pane 106 of the windshield 102. The ultraviolet lights 108 are molded onto an outer perimeter 111 of the exterior pane 106 of the windshield 102. The ultraviolet may be arranged in different configurations around the perimeter 111 of the windshield. Additional ultraviolet lights may be provided on the exterior pane to achieve a desirable tint percentage. In a preferred embodiment, the ultraviolet lights are disposed around each edge portion of the windshield to provide a uniform tint.

The present invention further comprises a sensor 110 coupled to the ultraviolet lights 108. The sensor 110 is configured to detect an output of the ultraviolet lights 108. The sensor 110 may detect the output of light from the ultraviolet lights 108 with a photo sensor. The photo sensor has an electronic component that detects the presence of visible light, infrared transmission (IR), and/or ultraviolet (UV) energy. The photo sensors include a photoconductive semiconductor material that has an electrical conductance that varies depending on the intensity of radiation striking the material. The photo sensor converts light energy to an electrical signal output which may relayed to a digital display 114 on a vehicle dashboard.

Additionally, an integrated control key 112 may be coupled to the sensor 110. The integrated control key 112 may be configured to control a percentage of tint produced by the ultraviolet lights 108 on the windshield 102. In a preferred embodiment, the integrated control key 112 is located on a vehicle dashboard. This provides an easy to read, real-time user interface, showing a graphical presentation of the current status of the tint percentage. Based on weather conditions, the time of day, and other driving conditions, the control key and control key display enables instantaneous and informed decisions to be made at a glance.

According to another embodiment of the present invention, the ultraviolet lights 108 are configured to change a light transmissivity responsive to an electric signal provided to the ultraviolet light. The ultraviolet lights may be contained in black light lamps that emit long-wave UVA radiation and little visible light. Fluorescent black light lamps use a phosphor on the inner tube surface, which emits UVA light instead of visible light. Some lamps use a deep-bluish-purple optical filter that blocks almost all visible light. The ultraviolet lights 108 may be disposed between the interior pane 104 and the exterior pane 106. The ultraviolet light emitted from the ultraviolet lights 108 adjusts the tint between 5% and 50% visibility.

According to another embodiment of the present invention, the integrated control key 112 is coupled to a digital display 114 that indicates a tint percentage. The integrated control key 112 is configured to receive a user input signal and adjust the electric signal responsive to the received input.

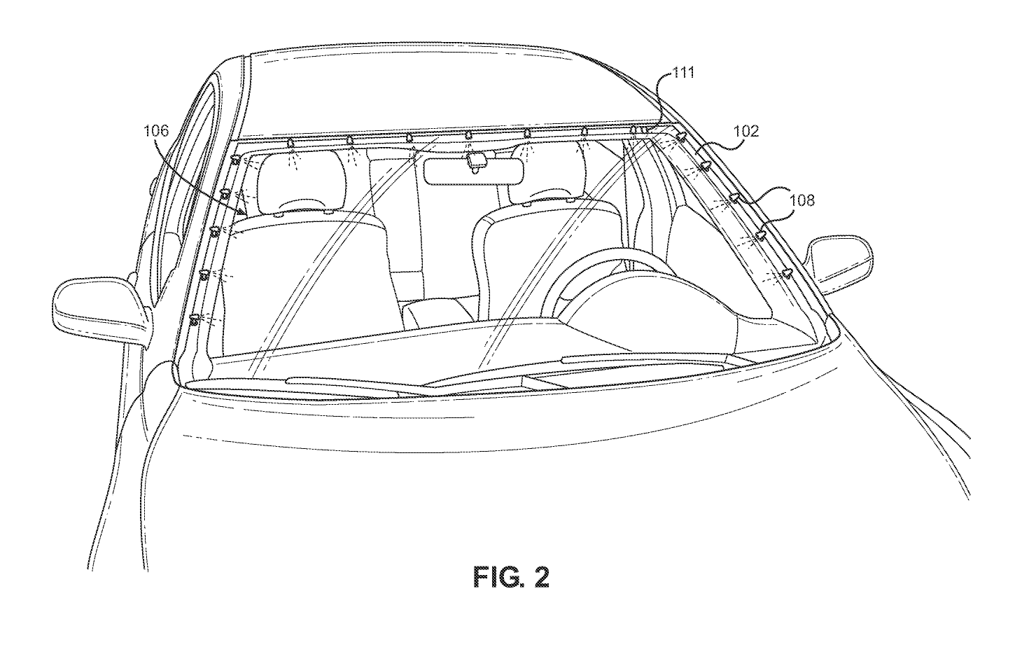

Referring now to FIG. 2, there is shown a windshield 102 with an adjustable tint according to one embodiment of the present invention. The apparatus provides a device that enables a driver to adjust the tint of a window or windshields of a vehicle, motorcycle or other automobile, for superior vision in all lighting conditions. The device includes windows and windshields 102 with a series of molded ultraviolet (UV) lights 108 positioned around the perimeter 111 of the windshield, whereby a built-in sensor is configured for controlling the lights. The ultraviolet lights may be disposed on the exterior pane 106 of the windshield 102.

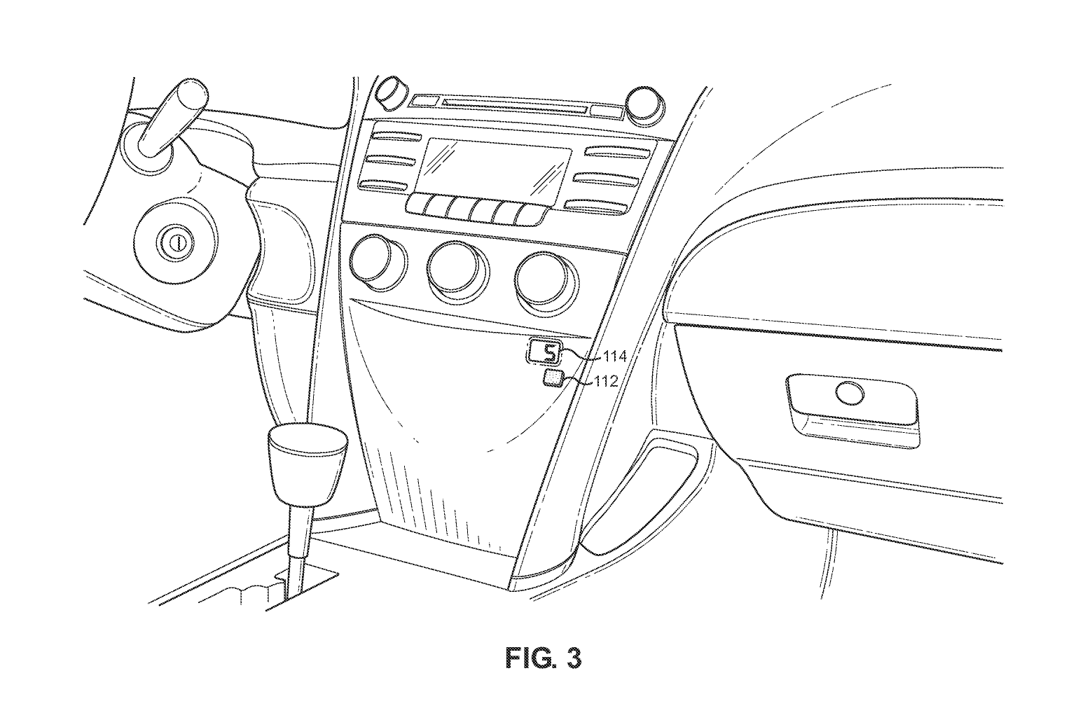

Referring now to FIG. 3, there is shown an integrated control key 112 for adjusting the window tint according to one embodiment of the present invention. The dashboard-mounted control keys and display are brightly lit in low light conditions. The present invention can include a pair of integrated control keys 112 located on the vehicle's dashboard or center console. These buttons are configured for controlling the percentage of tint that is on the windshield.

These buttons can comprise up and down arrow keys for determining the amount of tint thereon, with 50% being the lightest and 5% being the darkest. A digital display 114 above the arrow keys can clearly state the current selected percentage views of windshields in a lightly tinted and darkly tinted state. The windows and windshield can be designed to accommodate all vehicle makes and models and motorcycles. From the interior of the vehicle, an individual can press the up and down arrows in order to determine the amount of UV light that is directed towards the windshield, thereby determining the amount of tint on the windshield.

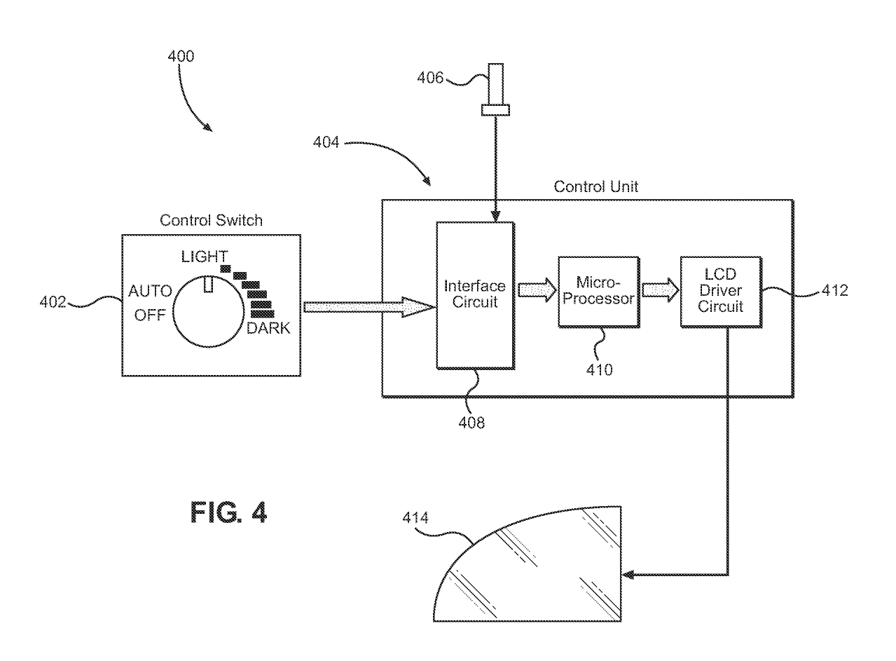

FIG. 4 shows a control system 400 for the adjustable tint system according to one embodiment of the present invention. The control system includes of a control switch 402 which send the user setting of OFF, AUTO, manual setting of LIGHT to DARK to the control unit 404. The control unit 404 takes inputs of the control switch 402 and sensor 406 via the interface circuit 408 to the microprocessor 410. The microprocessor 410 then calculates a voltage for the ultraviolet lights that corresponds to the degree of tint with respect to the amount of sunlight. After the calculation, the microprocessor 410 outputs the voltage to the LCD driver circuit 412 which sends the corresponding voltage to the ultraviolet lights disposed on the windshield 414.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tint-adjustable window glass, comprising:
a window having an interior pane and an exterior pane, wherein the interior pane and exterior pane are substantially parallel;
a plurality of ultraviolet lights disposed on the exterior pane of the windshield, wherein the ultraviolet lights are disposed along an outer perimeter of the exterior pane;
a sensor coupled to the ultraviolet lights, wherein the sensor is configured to detect an output of the ultraviolet lights; and
an integrated control key coupled to the sensor, wherein the integrated control key is configured to control a percentage of tint produced by the ultraviolet lights on the windshield.

2. The apparatus of claim 1, wherein the ultraviolet lights are configured to change a light transmissivity of the window responsive to an electric signal provided to the ultraviolet light.

3. The apparatus of claim 1, wherein the integrated control key is located on a vehicle dashboard.

4. The apparatus of claim 1, wherein the sensor detects the output of light from the ultraviolet lights with a photo sensor.

5. The apparatus of claim 4, wherein the photo sensor converts light energy to an electrical signal output.

6. The apparatus of claim 1, wherein the ultraviolet lights are disposed between the interior pane and the exterior pane.

7. The apparatus of claim 1, wherein a light emitted from the ultraviolet lights adjusts the tint between 5% and 50% visibility.

8. The apparatus of claim 1, wherein the integrated control key is coupled to a digital display that indicates a tint percentage.

9. The apparatus of claim 1, wherein integrated control key is configured to receive a user input signal and adjust the electric signal to the ultraviolet lights responsive to the received input.

10. The apparatus of claim 1, wherein the windows comprise a photochromic film layer.
